(19) United States
(12) Patent Application Publication
(10) Pub. No.: US 2026/0287251 A1
(43) Pub. Date: Sep. 24, 2026

(54) A method of and apparatus for reliquefying of boil-off gas stream obtained from liquefied gas in a gas storage of a floating storage unit

(71) Applicant: WÄRTSILÄ GAS SOLUTIONS NORWAY AS, Asker (NO)

(72) Inventors: Carl Jørgen RUMMELHOFF, Asker (NO); Lars GRØNNÆSS, Asker (NO)

(73) Assignee: WÄRTSILÄ GAS SOLUTIONS NORWAY AS, Asker (NO)

(21) Appl. No.: 19/474,329

(22) PCT Filed: Apr. 11, 2023
(86) PCT No.: PCT/EP2023/059393

§ 371 Date: Oct. 10, 2025

(51) Int. Cl. F25J 1/00; F17C 13/00; F17C 13/02; F25J 1/02

(52) U.S. Cl. CPC F25J 1/0025; F17C 13/004; F25J 1/0225; F25J 1/0244; F25J 1/0277; F17C 13/025; F17C 2223/0153; F17C 2227/0351; F17C 2250/03; F17C 2250/043; F17C 2265/034; F17C 2265/038; F25J 2270/90

(57) ABSTRACT

The present disclosure relates to an exemplary method of reliquefying of boil-off gas stream obtained from liquefied gas in a gas storage of a floating storage unit by leading boil-off gas from the gas storage to a gas compressor and increasing pressure of the boil-off gas, providing pressurized boil-off gas, leading the pressurized boil-off gas to a first condenser, and reliquefying at least part of the pressurized boil-off gas forming a first reliquefied and pressurized gas portion and remaining portion of the pressurized boil-off gas, reliquefying at least part of the remaining portion of the pressurized boil-off gas in a second condenser forming a second reliquefied and pressurized gas portion, expanding a majority of the first and the second reliquefied and pressurized gas portions to lower pressure, and introducing the reliquefied gas portions back into the gas storage.

### TECHNICAL FIELD

The present invention relates to a method of reliquefying of boil-off gas stream obtained from liquefied gas in a gas storage of a floating storage unit according to the preamble of claim 1.

The present invention relates to an apparatus for reliquefying of boil-off gas stream obtained from liquefied gas in a gas storage of a floating storage unit according to the preamble of another independent claim.

### BACKGROUND ART

It is commonly known to store gas in liquefied state. Composition which is in gaseous phase in normal atmospheric conditions can be liquefied by lowering its temperature and/or increasing its pressure. Examples of liquefied gases include liquid air, liquefied ammonia, liquefied natural gas, and liquefied petroleum gas, but also many other gases may be liquefied respectively. Liquefied gas storage may be a land-based facility or a floating storage and regasification unit.

During loading of tanks and storage of liquefied gas such as LPG in the tanks, liquefied gas tends to evaporate. So called boil-off gas will be created by evaporation of the gas from the liquid portion of the gas in the tank. Formation of boil-off gas may increase the pressure in the tank excessively and therefore pressure must be relieved. It is possible to vent the gas straight to the atmosphere, or through flaring, but that is not a sustainable manner of taking care of the problem.

Therefore, there is an obvious need for re-liquefaction of such portion of evaporated gas which is not intended for use in a gas consumer. In order to prevent or minimize loss of gas by the build-up of boil-off gas in the tank, a system may be provided to re-liquefy the boil-off gas so that it can be returned to the storage tank in a liquefied state. This can be achieved by compression and cooling of the boil-off gas. In many systems, the compressed boil-off gas is cooled and reliquefied making use of sea water as a heat sink.

Document EP2702311 A1 discloses a method of cooling a boil-off gas stream from a liquefied cargo, where the cargo itself acts as working medium of the cooling system. The method comprising at least the steps of compressing a boil-off gas stream from said liquefied cargo in two or more stages of compression to provide a compressed boil-off gas discharge stream; cooling the compressed boil-off gas discharge stream to provide a cooled vent stream and a cooled compressed boil-off gas stream; expanding, optionally after further cooling, a portion of the cooled compressed boil-off gas stream to provide an expanded cooled boil-off gas stream; heat exchanging the expanded cooled boil-off gas stream against the cooled vent stream to provide a further cooled vent stream. In such a method cooling capacity is dependent on the obtainable pressure after compression of the boil-off gas stream so that increased capacity requires increased compressor work, and/or on cooling capacity of the heat ex-changing process, which typically relies on the seawater. Capacity requirement of a re-liquefaction system is also different for different gas composition such that increased proportion of easily volatile components, such light hydrocarbons, requires higher pressure level to condensate. As a conclusion, capacity of sea-water-based cooling may be limited in certain situations.

An object of the invention is to provide a method of reliquefying of boil-off gas from liquefied gas storage, in which liquefaction capacity is considerably improved compared to the prior art solutions.

### DISCLOSURE OF THE INVENTION

Objects of the invention can be met substantially as is disclosed in the independent claims and in the other claims describing more details of different embodiments of the invention.

According to the invention boil-off gas stream obtained from liquefied gas in a gas storage of a floating storage unit is reliquefied, comprising steps of
leading boil-off gas from the gas storage to a gas compressor and increasing pressure of the boil-off gas, providing pressurized boil-off gas,
leading the pressurized boil-off gas to a first condenser, and reliquefying at least part of the pressurized boil-off gas forming a first reliquefied and pressurized gas portion and remaining portion of the pressurized boil-off gas,
reliquefying at least part of the remaining portion of the pressurized boil-off gas in a second condenser forming a second reliquefied and pressurized gas portion,
expanding the first and the second reliquefied and pressurized gas portions to lower pressure and introducing majority of the reliquefied gas portions back into the gas storage,
in the method the second condenser comprises a thermoelectric cooler. The thermoelectric cooler comprising a first heat exchanger through which the remaining portion of the pressurized boil-off gas stream flows and reliquefies therein at least partially, and a second heat exchanger through which a heat transfer medium flows, and that condensing of the thermoelectric cooler is controlled by controlling electric power input to the thermoelectric cooler.

This way condensing of the apparatus is less dependent on the available temperature the heat transfer medium because the thermoelectric cooler provides lower operating temperature to the first heat exchanger in controllable manner. Thus, excess amount of boil-off gas is efficiently reliquefied and returned back to the gas storage.

According to an embodiment of the invention the first condenser comprises a heat exchanger which extracts heat from the pressurized boil-off gas and transferred to sea water directly or indirectly thus reliquefying at least part of the pressurized boil-off gas.

Since the method is applied in a floating storage unit, using the sea water as a heat sink for initial, or the first condensing stage, for receiving the excess heat is advantageous and cost-effective means. This way a considerable portion of the gas can be reliquefied simply with the seawater.

According to an embodiment of the invention the second heat exchanger of the thermoelectric cooler transfers heat to sea water directly or indirectly.

Using the seawater for receiving heat from the thermoelectric cooler is advantageous and cost-effective.

According to an embodiment of the invention the first condenser comprises a heat exchanger which extracts heat from the pressurized boil-off gas and transferred to sea water directly or indirectly thus reliquefying at least part of the pressurized boil-off gas and the second heat exchanger of the thermoelectric cooler transfers heat to sea water directly or indirectly.

Since the method is applied in a floating storage unit, using the sea water as a heat sink for both the initial condensing stage and the second condenser is advantageous and cost-effective means because a common pipework can be utilized. This makes the system simpler, saves material, and space in the floating storage.

According to an embodiment of the invention the method comprises steps of separating the first reliquefied and pressurized gas portion from the remaining portion of the pressurized boil-off gas in a first gas-liquid separator downstream or in the first condenser, and leading the remaining portion of the pressurized boil-off gas, separated from the first reliquefied and pressurized gas portion, to the second condenser and reliquefying at least part of the remaining portion of the pressurized boil-off gas forming the second reliquefied and pressurized gas portion and expanding the first reliquefied and pressurized gas portion and the second reliquefied and pressurized gas portion separately, and after being expanded to lower, common pressure, combining a majority of the first and the second reliquefied gas portions and leading the combined stream back to the gas storage.

In this embodiment the outcome from the first condenser, i.e. the first reliquefied and pressurized gas portion from the remaining portion of the pressurized boil-off gas are separated from each other, and only the remaining portion of the pressurized boil-off gas, that is the gaseous part of the outcome from the first condenser, is led to the second condenser. This way the capacity of the second condenser need not to be used for further cooling of the first reliquefied and pressurized gas portion and/or arranging the flow of the already reliquefied portion through the second condenser, thus avoiding unnecessary compression work, but the capacity of the second condenser is used solely for condensing the remaining portion of the pressurized boil-off gas.

According to an embodiment of the invention the step of increasing pressure of the boil-off gas comprises two or more stages and cooling the partially pressurized boil-off gas between two compression stages in a liquid pool heat exchanger and wherein at least one of the first reliquefied and pressurized gas portion and the second reliquefied and pressurized portion is cooled in the liquid pool heat exchanger prior to expanding to lower pressure wherein a pond of liquid gas is formed at the bottom part of the liquid pool heat exchanger which receives heat from the cooled reliquefied and pressurized gas portion.

This provides an efficient way of improving the compression process and reliquefaction of the gas, utilizing cooling potential of expansion of reliquefied and pressurized gas.

According to an embodiment of the invention the first reliquefied and pressurized gas portion comprise those components of the boil-off gas capable, at the prevailing pressure, of reliquefication at the temperature of the seawater and the thermoelectric cooler reliquefies the remaining components of the boil-off gas. This provides an effect of obtaining partial liquefaction of the gas with solely using the cooling capacity of the sea water.

According to an embodiment of the invention second condenser is controlled by controlling the thermoelectric cooler and electric power input to the thermoelectric cooler is controlled by measuring pressure of the gas upstream the thermoelectric cooler, setting a target value to the pressure, comparing the measured value to the target value and controlling the electric power input to the thermoelectric cooler based on a signal obtained using the measured and target pressure value.

Pressure of the gas upstream the second condenser provides good feedback for controlling the second condenser because condensing of gas effect efficiently to the pressure of the gas. For example, liquid propane has a density that is approximately 270 times larger than the density of gaseous propane at atmospheric pressure and temperature. Preferably, when operating, the compressors, which are preferably piston compressors, are run with constant flow rate and pressure of the compressed and reliquefied gas is controlled by controlling the gas condensing in the second condenser.

An apparatus for reliquefying of boil-off gas stream obtained from liquefied gas in a gas storage of a floating storage unit according to the invention comprises
a gas compressor for increasing pressure of the boil-off gas providing pressurized boil-off gas,
a first condenser for reliquefying at least part of the pressurized boil-off gas,
a second condenser for reliquefying at least part of the remaining portion of the pressurized boil-off gas
at least one valve for expanding reliquefied and pressurized gas portions to lower pressure,
the second condenser comprises a thermoelectric cooler comprising a first heat exchanger in which the remaining portion of the pressurized boil-off gas stream is arranged to reliquefy, and a second heat exchanger in which a heat receiving transfer medium is arranged to flow, and a power management system for supplying electric power to the thermoelectric elements of the thermoelectric cooler in controllable manner.

By means of such an apparatus condensing capacity is less dependent on the available temperature of the heat transfer medium because the thermoelectric cooler provides lower operating temperature to the first heat exchanger in controllable manner. Thus, excess amount of boil-off gas is efficiently reliquefied and returned back to the tank.

According to an embodiment of the invention the first condenser comprises a heat exchanger which is arranged to extract heat from the pressurized boil-off gas and to transfer heat to sea water directly or indirectly thus reliquefying at least part of the pressurized boil-off gas.

Using the sea water as a heat sink for initial, or the first condensing stage, for receiving the excess heat is advantageous and cost-effective means. This way a considerable portion of the gas can be reliquefied simply with the seawater.

According to an embodiment of the invention the second heat exchanger of the thermoelectric cooler is arranged to transfer heat to sea water directly or indirectly. Using the seawater for receiving heat from the thermoelectric cooler is advantageous and cost-effective.

According to an embodiment of the invention the first condenser comprises a heat exchanger which is arranged to extract heat from the pressurized boil-off gas and to transfer heat to sea water directly or indirectly thus reliquefying at least part of the pressurized boil-off gas and the second heat exchanger of the thermoelectric cooler is arranged to transfer heat to sea water directly or indirectly. Using the sea water as a heat sink for both the initial condensing stage and the second condenser is advantageous and cost-effective means because a common pipework can be utilized. This makes the system simpler, saves material, and space in the floating storage.

According to an embodiment of the invention the apparatus comprises a first gas-liquid separator after the first condenser arranged to separate the first reliquefied and pressurized gas portion from the remaining portion of the pressurized boil-off gas, and a second gas-liquid separator after the second condenser.

In this embodiment the outcome from the first condenser, i.e. the first reliquefied and pressurized gas portion from the remaining portion of the pressurized boil-off gas can be separated from each other, and only the remaining portion of the pressurized boil-off gas, that is the gaseous part of the outcome from the first condenser, will be led to the second condenser. This way the capacity of the second condenser need not to be used for further cooling of the first reliquefied and pressurized gas portion and/or arranging the flow of the already reliquefied portion through the second condenser, thus avoiding unnecessary compression work, but the capacity of the second condenser is used solely for condensing the remaining portion of the pressurized boil-off gas.

According to an embodiment of the invention the gas compressor comprising two or more stages, and a gas cooler between two compression stages and the gas cooler comprises a liquid pool heat exchanger.

This provides an efficient way of improving the compression process and reliquefaction of the gas, utilizing cooling potential of expansion of reliquefied and pressurized gas.

According to an embodiment of the invention a pressure probe is arranged upstream the thermoelectric cooler arranged in data transfer communication with the power management system of the thermoelectric cooler.

A thermoelectric cooler is a solid-state semiconductor device that converts DC electric power into temperature difference. When a voltage is applied to thermoelectric cooler, an electrical current is produced. This current induces the Peltier effect. With this effect, heat is moved from the cold side to the hot side.

In this context the word “gas” may refer to both gaseous and liquid gas and the state of the gas is referred to by stating the phase of the gas when needed. It should be also understood that the word “gas” refers to a mixture of various components which may vary along the reliquefying process.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in dependent claims are mutually freely combinable unless otherwise explicitly stated.

### BRIEF DESCRIPTION OF DRAWINGS

In the following, the invention will be described with reference to the accompanying exemplary, schematic drawings, in which

FIG. 1 illustrates an apparatus for reliquefying of boil-off gas stream according to an embodiment of the invention,

FIG. 2 illustrates an apparatus for reliquefying of boil-off gas stream according to another embodiment of the invention,

FIG. 3 illustrates an apparatus for reliquefying of boil-off gas stream according to another embodiment of the invention, and

FIG. 4 illustrates an apparatus for reliquefying of boil-off gas stream according to another embodiment of the invention.

### DETAILED DESCRIPTION OF DRAWINGS

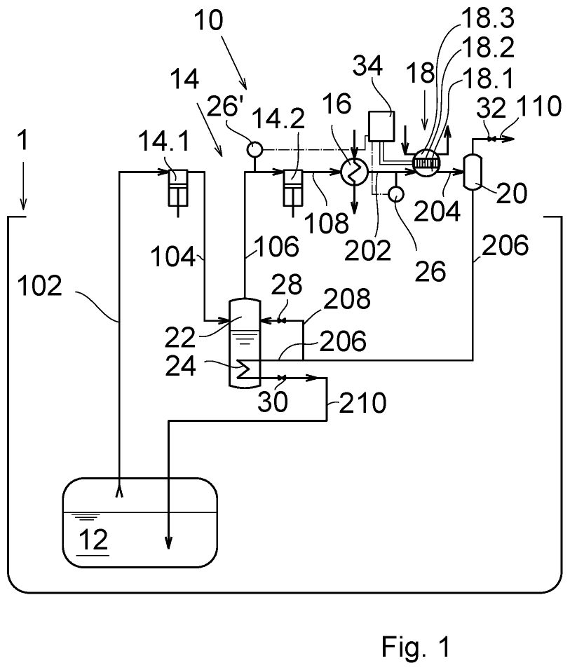

FIG. 1 depicts schematically an apparatus 10 for reliquefying of boil-off gas stream according to an embodiment of the invention. As is known in the art a so-called boil-off gas is generated from liquefied gas stored in a gas storage, which may also be referred to as a tank 12. Figure in describes an open cycle reliquefaction system. The apparatus 10 is connected to the tank 12 such that a gas feed line 102, which is arranged for feeding boil-off gas to the apparatus 10 and removing the boil-off gas from the tank 12, opens to upper part, so called ullage space, of the tank 12 and such that a liquefied gas return line 210 is arranged for feeding reliquefied gas from the apparatus 10 back to the tank 12.

The apparatus 10 comprises a gas compressor 14, which has at least two stages 14.1,14.2. The compressor is preferable a reciprocating piston compressor. The compressor 14 may be for example a piston compressor. Advantageously, there is a gas cooler 22 arranged between the compressor stages 14.1,14.2. An outlet of the first compressor stage 14.1 connected to a gas cooler 22 by means of a first gas line 104 and the gas cooler 22 is connected to an inlet of the second compressor stage 14.2 by means of a second gas line 106. The apparatus comprises a first condenser 16 which is connected to the outlet of the second compressor stage 14.2 by means of a third gas line 108. The first condenser 16 is a heat exchanger in which heat from the pressurized boil-off gas is transferred preferably to sea water, directly or indirectly. The first condenser 16 may be referred to as passive heat exchanger because heat transfer is based on convection on the surfaces and conduction through heat exchanger material. There is also a second condenser 18 arranged to the apparatus 10 which is connected to an outlet of the first condenser 16 by means of a first condensate gas line 202. The second condenser 18 is connected to a gas-liquid separator 20 by means of a second condensate gas line 204. As it becomes clear from the FIG. 1 the compressor 14, the first condenser 16 and the second condenser 18 are coupled successively upstream the gas-liquid separator 20 in the flow direction of the gas. The gas-liquid separator 20 comprises to two outlets, one of which is coupled to a vent gas line 110, and one of which is coupled to a third condensate line 206. The vent gas line 110 is provided with a valve 32 reducing pressure of vent gas before guiding to desired further processing. For a sake of clarity the first condenser 16, the second condenser 18 and the gas-liquid separator 20 are illustrated as separate devices, but they can be also integrated into one aggregate device having corresponding functionalities.

The second condenser 18 comprises a thermoelectric cooler 18.1,18.2,18.3. The thermoelectric cooler operates according to the Peltier effect known as such. There is a first heat exchanger 18.1 through which heat is removed from gas stream and transferred to thermoelectric elements 18.2 and a second heat exchanger 18.3 through which heat is removed from thermoelectric elements 18.2 and transferred to a heat transfer medium arranged to flow through the second heat exchanger 18.3. The second heat exchanger 18.3 of the thermoelectric cooler transfers heat preferably to sea water directly or indirectly.

In other words, the thermoelectric cooler may be considered as an active heat exchanger, being a controllable solid-state device, which transfers heat from first heat exchanger 18.1 of the cooler to the second heat exchanger 18.3. The thermoelectric cooler is provided with a power management system 34 for supplying electric power to the thermoelectric elements of the thermoelectric cooler in controllable manner. By controlling the electric power input to the thermoelectric cooler, it is possible to control heat transfer of the thermoelectric cooler, and control condensing power with which the gas is condensed in the second condenser 18.

The gas stream is reliquefied in the first heat exchanger of the thermoelectric cooler 18 at least partially, preferably majority of gas is liquefied, and cooling and/or condensing of the first heat exchanger of the thermoelectric cooler 18.1,18.2,18.3 is controlled by controlling electric power input to the thermoelectric cooler. The second condenser 18 practically finalizes the reliquefaction of the gas, thanks to its controllable condensing power, of the boil-off gas, though some insignificant amount of residue gas may remain uncondensed.

In the following the gas cooler 22 is described in more detailed manner. The gas cooler comprises a liquid pool heat exchanger wherein a pond of liquid gas is formed at the bottom part of the liquid pool heat exchanger which pond receives heat from the first reliquefied and pressurized gas portion. The gas cooler 22 is configured to cool the partially pressurized boil-off gas between the compressor stages 14.1,14.2. Another functionality of the gas cooler 22 is cooling of reliquefied gas prior to its feeding back to the tank 12. The gas cooler 22 is provided with a heat transfer device 24 at its lower part, such as a tube coil or a tube bundle, to the input of which the third condensate line 206 is connected via which reliquefied and pressurized gas is led to the heat transfer device 24. The heat transfer device 24 is connected from its outlet to a liquefied gas return line 210 by means of which reliquefied gas can be returned to the tank 12. The liquefied gas return line is provided with a valve 30 for expanding reliquefied and pressurized gas portions to lower pressure before entering back to the tank 12.

The gas cooler 22 is a vessel which has a space inside. The third condensate line 206 is provided with a branch line 208 which opens into the space inside the gas cooler 22 at upper part thereof. There is a valve 28 arranged to the branch line 208 which results in expansion of the condensed i.e. reliquefied gas prior to entering the space in the gas cooler 22. Due to expansion into lower pressure the gas in liquid phase at least partly evaporates and cools down. As it becomes apparent from the FIG. 1 pressure in the branch line needs to be lowered to about the pressure prevailing at the outlet of the first compressor stage 14.1. The expanded reliquefied gas mixes in the vessel with the pressurized boil-off gas fed from the first compressor stage 14.1 into the gas cooler and thus the gas which exits the gas cooler 22 to the second compressor stage 14.2 is cooler than the gas coming from the first compressor stage 14.1. The mass flow of the gas fed into the gas cooler 22 via the branch line 208 is small compared to the mass flow returned to the tank 12 via the liquefied gas return line 210 and therefore the vast majority, that is more than 85% of the first and the second reliquefied and pressurized gas portions is introducing the reliquefied gas portions back into the gas storage 12. Since there is a flow of gas via the branch line 208 to the gas cooler, the gas flow through the second compressor stage 14.2 is greater than through the first compressor stage 14.1.

The heat transfer device 24 is arranged to lower part of the gas cooler 22 such that, when in use, the heat transfer device is immersed in liquefied gas. The liquefied gas in the gas cooler 22 is at lower temperature than the pressurized boil-off gas coming from the liquefied gas return line 210 and the gas-liquid separator 20 because it has been discharged into lower pressure through the valve 28 in the branch line 208, and cooled down by the expansion into lower pressure.

The apparatus for reliquefying of boil-off gas stream obtained from the tank 12 according to embodiment of the FIG. 1 is operated in the following manner. According to the present invention excess amount of boil-off gas is efficiently reliquefied and returned back to the tank. The apparatus according to the invention is started or its power is controlled for example based on measured pressure in the tank. When the pressure in the tank is more than a set limit value or a range the apparatus is stated or its reliquefaction power is increased so that portion of boil-off gas may be reliquefied and returned back to the tank in liquid form. During operation of the apparatus boil-off gas is led from the gas storage tank 12 to the gas compressor 14 and where pressure of the boil-off gas is increased providing pressurized boil-off gas. In this connection the term pressurized means that the pressure is increased from the level prevailing in the tank 12. Even if only two stages are shown, the compressor comprises preferably two or more stages 14.1, 14.2, wherein the pressure of the boil-off gas is increased in two stages, respectively. Additionally, the boil-off gas is cooled between compression stages, which may be called as inter-cooling, by means of the gas cooler 22.

Inter-cooling takes place in the open space of the gas cooler 22 such that the boil-off gas is allowed to mix with expanded pressurized boil-off gas coming from the liquefied gas return line 210 and the gas-liquid separator 20, which cools down the gas in the open space of the gas cooler 22. The expanded reliquefied gas mixes in the vessel with the pressurized boil-off gas fed from the first compressor stage 14.1 into the gas cooler and thus the gas which exits the gas cooler 22 to the second compressor stage 14.2 is cooler than the gas coming from the first compressor stage 14.1.

Pressurized boil-off gas is next led from the compressor 14 to the first condenser 16, in which the gas is at least partially condensed by making use of cooling energy obtained from the sea water, directly or indirectly. The portion of condensed gas depends on the composition of the gas, condensing temperature of the gas which is available in the first condenser 16 and actual pressure of the boil-off gas. The condensing temperature is effected by temperature of the water in which the floating storage unit 1 is floating and usually it is not possible to obtain full liquefaction of the gas with the available sea temperature level. Since only part of the pressurized boil-off gas can be liquefied in the first condenser 16, the output of the first condenser comprises a first reliquefied and pressurized gas portion, which is in liquid form and remaining portion of the pressurized boil-off gas as a mixture. In the embodiment shown in the FIG. 1 the mixture of the first reliquefied and pressurized gas portion and remaining portion of the pressurized boil-off gas is led to the second condenser 18 in which major part of the remaining portion of the pressurized boil-off gas is condensed forming a second reliquefied and pressurized gas portion. In the second condenser 18 the remaining portion of the pressurized boil-off gas stream flows through the first heat exchanger 18.1 of the thermoelectric cooler and reliquefies therein, at a major portion of the gas stream. A suitable heat transfer medium flows through the second heat exchanger 18.3 and receives heat from the pressurized boil-off gas stream. Condensing capacity of the thermoelectric cooler is operated by controlling electric power input to the thermoelectric cooler. When electric power is brought to the thermoelectric cooler condensing capacity is enhanced considerably from a capacity which would be available with sole sea water as a heat sink. This provides an advantage particularly when temperature of the water around the unit 1 is increased. This may take place particularly in a confined areas such as harbours when operating the apparatus 10 for longer periods of time.

Preferably electric power input to the thermoelectric cooler is controlled by measuring pressure of the gas upstream the thermoelectric cooler with a pressure probe 26. A target value to the pressure upstream the thermoelectric cooler is set, and the measured value is compared to the target value. The electric power input to the thermoelectric cooler is controlled based on a signal obtained using the measured and target pressure value.

Optionally the there is a second pressure probe 26′ arranged in the apparatus 10 which is at immediate proximity to inlet of the last stage of the compressor, in case the compressor comprises several stages, or at immediate proximity to inlet of a single compressor in case the compressor comprises only one compressor stage. When the apparatus is provided with pressure probes 26′,26 at both sides of the compressor, it is operated such that differential pressure is measures across the last (or a sole) compressor stage 14.2. The measured differential value is compared to a target value and the electric power input to the thermoelectric cooler is controlled based on a signal obtained using the measured differential pressure and target differential pressure value. When this differential pressure gets above a pre-defined value then power is started to apply to the thermoelectric cooler, and thus controlling the compressor at that a pre-defined differential pressure. This feature is useful on existing ships with compressors that has pressure ratio limitations compared to what new compressors have.

In the case of FIG. 1 the first reliquefied and pressurized gas portion obtained from the first condenser and the second reliquefied and pressurized gas portion obtained from the second condenser 18 are mixed with each other in the second condensate gas line 204. The stream of gas coming out from the first heat exchanger 18.1 is led to the gas-liquid separator 20 in which any uncondensed gaseous components in the reliquefied gas are separated from reliquefied gas. Eventually, and prior to feeding back to the tank 12 the first and the second reliquefied and pressurized gas portions are expanded to lower pressure, after which reliquefied gas portions are introduced back into the gas storage tank 12. The expansion is accomplished by leading the reliquefied gas through the valve 30.

The first reliquefied and pressurized gas portion comprise those components of the boil-off gas which are capable, at the prevailing pressure, of reliquefication at the temperature of the seawater and the thermoelectric cooler reliquefies a major part of the remaining components of the boil-off gas.

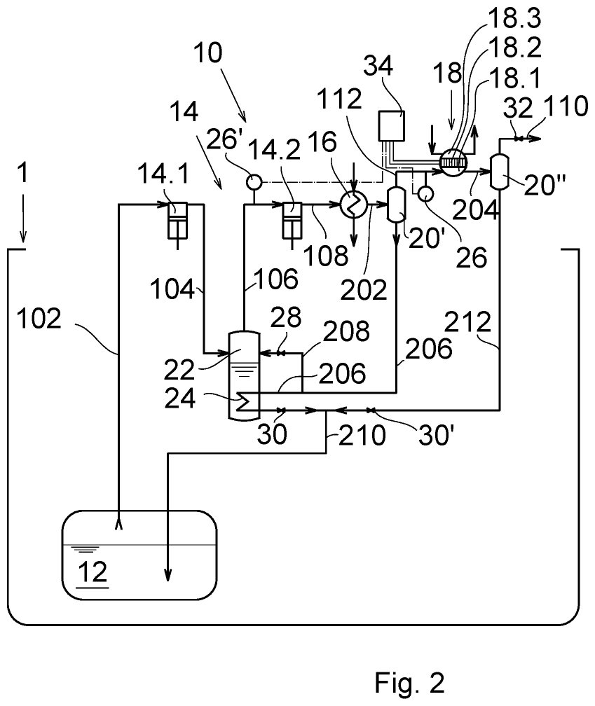

FIG. 2 depicts schematically an apparatus 10 for reliquefying of boil-off gas stream according to another embodiment of the invention.

Like the embodiment shown in the FIG. 1 the apparatus 10 is connected to the tank 12 such that gas feed line 102, which is arranged for feeding boil-off gas to the apparatus 10 opens to upper part above the level of the liquefied gas in the tank 12 and such that liquefied gas return line 210 is arranged for feeding reliquefied gas from the apparatus 10 back to the tank 12. In general, the embodiment of the FIG. 2 corresponds otherwise to that of the FIG. 1 but here both the first condenser 16 and the second condenser 18 are provided with gas-liquid separator 20,20′ downstream thereof, also the returning route of the liquefied gas differs from that of the embodiment in FIG. 1.

The apparatus 10 comprises a gas compressor 14, which has at least two stages 14.1,14.2. There is a gas cooler 22 arranged between the compressor stages 14.1,14.2 as in the embodiment of the FIG. 1. An outlet of the first compressor stage 14.1 connected to the gas cooler 22 by means of a first gas line 104 and the gas cooler 22 is connected to an inlet of the second compressor stage 14.2 by means of a second gas line 106. The gas cooler 22 is similar to that disclosed in connection with FIG. 1 and it is also operated in corresponding manner and is therefore it is not disclosed in more detailed manner here, and the disclosure of the gas cooler 22 itself in connection with FIG. 1 is applicable to the FIG. 2.

The apparatus 10 comprises a first condenser 16 which is connected to the outlet of the second compressor stage 14.2 by means of a third gas line 108. The first condenser 16 is a passive heat exchanger in which heat from the pressurized boil-off gas is transferred preferably to sea water, directly or indirectly. There is a first gas-liquid separator 20′ separator after the first condenser 16. The first gas-liquid separator 20′ is arranged to separate the first reliquefied and pressurized gas portion and the remaining portion of the pressurized boil-off gas from each other. The first gas-liquid separator 20′ comprises to two outlets, one of which is coupled to a fourth gas line 112, and one of which is coupled to a third condensate line 206.

There is also a second condenser 18 arranged to the apparatus 10 which is connected to an outlet of the first gas-liquid separator 20′ by means of the fourth gas line 112. The gas which is separated in the first gas-liquid separator 20′ is introduced to the second condenser 18 The second condenser 18 is connected to a second gas-liquid separator 20″ by means of a second condensate gas line 204. The second condenser 18 is similar to that disclosed in connection with FIG. 1 and it is also operated in corresponding manner and is therefore it is not disclosed in connection the FIG. 2. The second condenser 18 practically finalizes the reliquefaction of the gas, thanks to its controllable condensing power, of the boil-off gas, though some insignificant amount of residue gas may remain uncondensed.

In this embodiment the first condenser 16 condenses the gas at least partially by making use of cooling energy obtained from the sea water, directly or indirectly. The portion of condensed gas depends on the composition of the gas, condensing temperature of the gas which is available in the first condenser 16 and actual pressure of the boil-off gas. The condensing temperature is effected by temperature of the water in which the floating storage unit 1 is floating and usually it is not possible to obtain full liquefaction of the gas with the available sea temperature level. Since only part of the pressurized boil-off gas can be liquefied in the first condenser 16, the output of the first condenser comprises a first reliquefied and pressurized gas portion, which is in liquid form and remaining portion of the pressurized boil-off gas. The first reliquefied and pressurized gas portion is separated in the first gas-liquid separator 20′ and is led to the third condensate line 206. Only the remaining portion of the pressurized boil-off gas is led to the second condenser 18 through the fourth gas line 112. In the second condenser 18 major part of the remaining portion of the pressurized boil-off gas is condensed forming a second reliquefied and pressurized gas portion. In the second condenser 18 the remaining portion of the pressurized boil-off gas stream fed from the fourth gas line 112 flows through the first heat exchanger 18.1 of the thermoelectric cooler and reliquefies therein, at a major portion of the gas stream. A suitable heat transfer medium, which is preferably in heat transfer communication with the sea water, flows through the second heat exchanger 18.3 and receives heat from the pressurized boil-off gas stream. Condensing power the thermoelectric cooler 18 is operated by controlling electric power input to the thermo-electric cooler. When electric power is brought to the thermoelectric cooler condensing capacity is enhanced considerably from a capacity which would be available with sole sea water as a heat sink. Also, because the second condenser 18 receives and processes only the remaining portion of the pressurized boil-off gas from the first gas-liquid separator 20′ its capacity is more efficiently utilized for smaller flow rate.

The second condenser 18 is connected to the second gas-liquid separator 20″ by means of a second condensate gas line 204. The second gas-liquid separator 20″ comprises to two outlets, one of which is coupled to a vent gas line 110, and one of which is coupled to a fourth condensate line 212. The vent gas line 110 is provided with a valve 32 reducing pressure of vent gas before guiding to desired further processing. During normal operation the valve 32 is closed.

With regard to coupling of the gas cooler 22 in the embodiment of FIG. 2, contrary to the embodiment of the FIG. 1 the heat transfer device 24 immersed in liquefied gas at the lower part of the gas cooler 22 is here configured to cool only the reliquefied gas condensed in the first condenser 16, which is led from the first gas-liquid separator 20′ to the heat transfer device 24. The heat transfer device 24 in the gas cooler 22 is connected from its outlet to the liquefied gas return line 210 by means of which reliquefied gas can be returned to the tank 12. The third condensate line 206 is provided with a valve 30 at downstream side of the heat transfer device 24 for expanding reliquefied and pressurized gas portions to lower pressure before entering back to the tank 12. The fourth condensate line 212 is also connected to the gas return line 210 by means of which reliquefied gas from the second gas-liquid separator 20″ is returned to the tank 12. The fourth condensate line 212 is also provided with a valve 30′ by means of which second reliquefied and pressurized gas portion is expanded to lower pressure before combining the with the stream coming from the third condensate line 206. The liquefied gas in the gas cooler 22 is at lower temperature than the pressurized boil-off gas in the liquefied gas return line 210 and first the gas-liquid separator 20′ because it has been discharged into lower pressure through the valve 28 in the branch line 208.

The apparatus for reliquefying of boil-off gas stream obtained from the tank 12 according to embodiment of the FIG. 2 is operated in the following manner. According to the present invention excess amount of boil-off gas is efficiently reliquefied and returned back to the tank. The apparatus according to the invention is started or its capacity is controlled for example based on measured pressure in the tank. When the pressure in the tank is more than a set limit value or a range the apparatus is stated or its reliquefaction capacity is increased so that portion of boil-off gas may be reliquefied and returned back to the tank in liquid form. During operation of the apparatus boil-off gas is led from the gas storage tank 12 to the gas compressor 14 and where pressure of the boil-off gas is increased providing pressurized boil-off gas. In this connection the term pressurized means that the pressure is increased from the level prevailing in the tank 12. The compressor comprises two or more stages 14.1., 14.2, wherein the pressure of the boil-off gas is increased in two stages, respectively. Additionally, the boil-off gas is cooled between compression stages, which may be called as inter-cooling, by means of the gas cooler 22. Inter-cooling takes place in the open space of the gas cooler such that the boil-off gas is allowed to mix with expanded pressurized boil-off gas coming from the liquefied gas return line 210 and the gas-liquid separator 20, which cools down the gas in the open space of the gas cooler 22. The expanded reliquefied gas mixes in the vessel with the pressurized boil-off gas fed from the first compressor stage 14.1 into the gas cooler and thus the gas which exits the gas cooler 22 to the second compressor stage 14.2 is cooler than the gas coming from the first compressor stage 14.1.

Pressurized boil-off gas is next led from the compressor 14 to the first condenser 16, in which the gas is at least partially condensed by making use of cooling energy obtained from the sea water, directly or indirectly. The portion of condensed gas depends on the composition of the gas, condensing temperature of the gas which is available in the first condenser 16 and actual pressure of the boil-off gas. The condensing temperature is effected by temperature of the water in which the floating storage unit 1 is floating and usually it is not possible to obtain full liquefaction of the gas with the available sea temperature level. Not all of the pressurized boil-off gas can be liquefied in the first condenser 16, the output of the first condenser comprises a first reliquefied and pressurized gas portion, which is in liquid form and remaining portion of the pressurized boil-off gas. In the embodiment shown in the FIG. 2 the mixture of the first reliquefied and pressurized gas portion and remaining portion of the pressurized boil-off gas is led to first gas-liquid separator 20′ where the first reliquefied and pressurized portion is separated from remaining portion of the pressurized boil-off gas. The first reliquefied and pressurized gas portion comprise those components of the boil-off gas which are capable, at the prevailing pressure, of reliquefication at the temperature of the seawater and the thermoelectric cooler reliquefies a major part of the remaining components of the boil-off gas. The first gas-liquid separator 20′ may also be integrated with the first condenser and the first reliquefied and pressurized gas portion is separated from the remaining portion of the pressurized boil-off gas in a first gas-liquid separation chamber of the first condenser 16.

In the embodiment shown in the FIG. 2 the remaining portion of the pressurized boil-off gas is led to the second condenser 18, in which major part of the remaining portion of the pressurized boil-off gas is condensed forming a second reliquefied and pressurized gas portion. In the second condenser 18 the remaining portion of the pressurized boil-off gas stream is fed through the first heat exchanger 18.1 of the thermoelectric cooler and a major portion of the gas stream reliquefies therein. In the thermoelectric cooler major part of the remaining portion of the pressurized boil-off gas is condensed forming a second reliquefied and pressurized gas portion.

A suitable heat transfer medium, which is preferably in heat transfer communication with the sea water, flows through the second heat exchanger 18.3 and receives heat from the pressurized boil-off gas stream. Condensing power of the thermoelectric cooler 18 is operated by controlling electric power input to the thermoelectric cooler. When electric power is brought to the thermoelectric cooler, condensing capacity is enhanced considerably from a capacity which would be available with sole sea water as a heat sink.

Preferably electric power input to the thermoelectric cooler is controlled by measuring pressure of the gas in immediate vicinity upstream of the thermoelectric cooler with a pressure probe 26. A target value to the pressure upstream the thermoelectric cooler is set, and the measured value is compared to the target value. The electric power input to the thermoelectric cooler is controlled based on a signal obtained using the measured and target pressure value.

The gas, containing condensate and gaseous gas is led from the outlet of the second condenser to the second gas-liquid separator 20″ via a second condensate gas line 204. The second gas-liquid separator 20″ comprises two outlets, one of which is coupled to a vent gas line 110, and one of which is coupled to a fourth condensate line 212. The vent gas line 110 is provided with a valve 32 reducing pressure of vent gas before guiding to desired further processing.

In the case of FIG. 2 the first reliquefied and pressurized gas portion (in the third condensate gas line 206) and the second reliquefied and pressurized gas portion (in the fourth condensate gas line 212) are preferably mixed with each other prior to feeding back to the tank. The first reliquefied and pressurized gas portion is led to the heat transfer device 24 in the gas cooler 22 prior to its returning to the tank 12 via the liquefied gas return line 210. The first reliquefied and pressurized gas portion in third condensate line 206 expanded to lower pressure at downstream side of the heat transfer device 24 by the valve 30 before entering back to the tank 12.

The second reliquefied and pressurized gas portion is discharged from the second gas-liquid separator 20″ via the fourth condensate line 212. The second reliquefied and pressurized gas portion is expanded in the valve 30′ to lower pressure before entering back to the tank 12. The fourth condensate line 212 is also connected to the gas return line 210 by means of which reliquefied gas can be returned to the tank 12. The third condensate gas line 206 and the fourth condensate line 210 are combined with each other into the liquefied gas return line 210 after the streams are expanded separately in the valves 30, 30′.

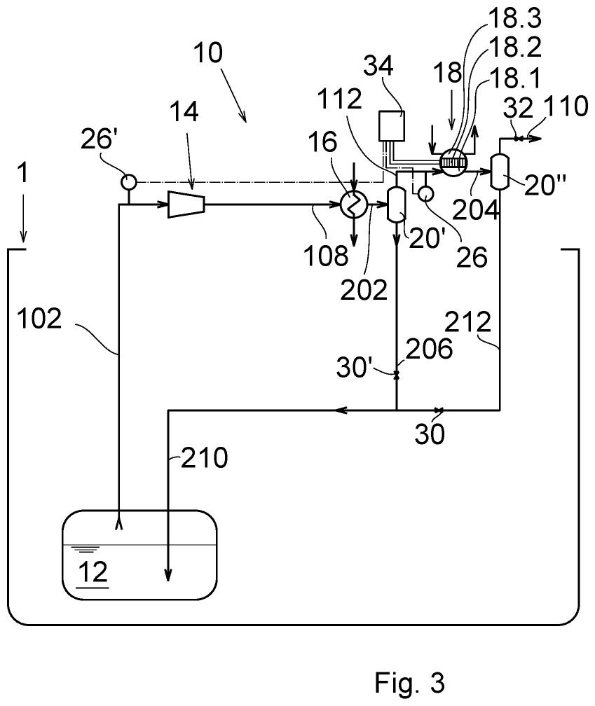

FIG. 3 discloses an embodiment of the invention otherwise similar to that shown in the FIG. 2 except that the compressor 14 comprises only one stage. As a consequence of that, the gas cooler 22 shown in the FIG. 2 is not needed and it is omitted. An outlet of the compressor 14 is directly connected with the first condenser 16 via the third gas line 108. The third condensate line 206 and the fourth condensate lines are combined to the liquefied gas return line 210 downstream to the valves 30′,30 provided in the condensate lines.

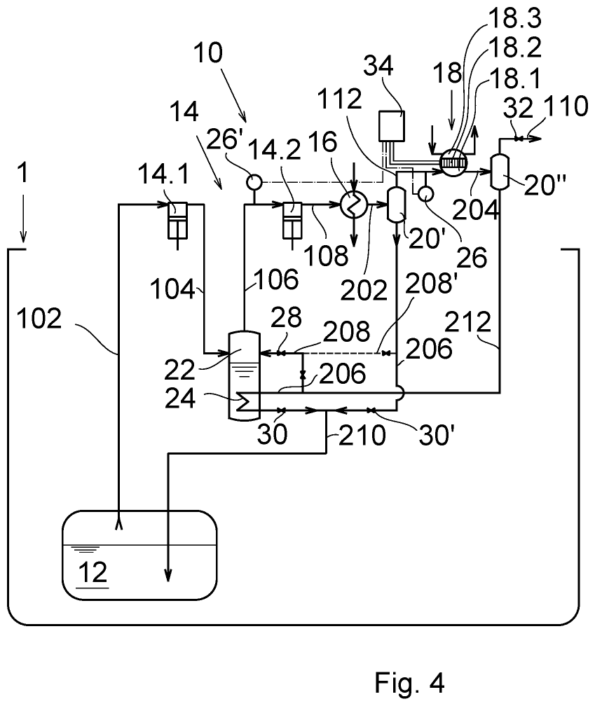

FIG. 4 discloses an optional modification of the invention otherwise similar to that shown in the FIG. 2 except that the heat exchanger 24 is connected to fourth condensate line 212 instead of the third condensate line 206. In practise, in some cases this may not be so attractive as the configuration in the FIG. 2 because the first condenser 16 is capable of condensing the majority of the pressurized boil-off gas. In some practical applications both of the fourth condensate line 212 and the third condensate line 206 may be arranged alternative connectable to the branch line 208.

While the invention has been described herein by way of examples in connection with what are, at present, considered to be the most preferred embodiments, it is obvious to the skilled person that, along with the technical progress, the basic idea of the invention can be implemented in many ways. The invention and its embodiments are thus not limited to the examples and samples described above but they may vary within the contents of patent claims and their legal equivalents. The details mentioned in connection with any embodiment above may be used in connection with another embodiment when such combination is technically feasible.

### PART LIST

a floating storage unit 1
an apparatus for reliquefying of boil-off gas stream 10
a gas storage 12
a gas compressor 14
compressor stages 14.1, 14,2
a first condenser 16
a second condenser 18
a thermoelectric cooler 18.1,18.2,18.3
a first heat exchanger 18.1
thermoelectric elements 18.2
a second heat exchanger 18.3
a gas-liquid separator 20
a first gas-liquid separator 20′
a second gas-liquid separator 20″
a gas cooler 22
a heat transfer device 24
a pressure probe 26
a valve 28
a valve 30
a valve 30′
a valve 32
a power management system 34
a gas feed line 102
a first gas line 104
a second gas line 106
a third gas line 108
a vent gas line 110
a fourth gas line 112
a liquefied gas return line 201
a first condensate gas line 202
a second condensate gas line 204
a third condensate line 206
a branch line 208
a liquefied gas return line 210
a fourth condensate line 212

1-14. (canceled)

15. A method of reliquefying of boil-off gas stream obtained from liquefied gas in a gas storage of a floating storage unit, the method comprising:
leading boil-off gas from the gas storage to a gas compressor and increasing pressure of the boil-off gas, providing pressurized boil-off gas;
leading the pressurized boil-off gas to a first condenser, and reliquefying at least part of the pressurized boil-off gas forming a first reliquefied and pressurized gas portion and remaining portion of the pressurized boil-off gas;
reliquefying at least part of the remaining portion of the pressurized boil-off gas in a second condenser forming a second reliquefied and pressurized gas portion;
expanding the first and the second reliquefied and pressurized gas portions to lower pressure and introducing a majority of the reliquefied gas portions back into the gas storage, wherein the second condenser includes a thermoelectric cooler including a first heat exchanger through which a remaining portion of the pressurized boil-off gas stream flows and reliquefies therein at least partially, and a second heat exchanger through which a heat transfer medium flows, and wherein condensing power of the thermoelectric cooler is controlled by controlling electric power input to the thermoelectric cooler.

16. A method according to claim 15, wherein the first condenser comprises:
a heat exchanger to extract heat from the pressurized boil-off gas and to transfer heat to sea water directly or indirectly thus reliquefying at least part of the pressurized boil-off gas.

17. A method according to claim 15, wherein the second heat exchanger of the thermoelectric cooler transfers heat to sea water directly or indirectly.

18. A method according to claim 15, wherein the method comprises:
separating the first reliquefied and pressurized gas portion from the remaining portion of the pressurized boil-off gas in a first gas-liquid separator downstream or in the first condenser;
leading the remaining portion of the pressurized boil-off gas, separated from the first reliquefied and pressurized gas portion, to the second condenser and reliquefying at least part of the remaining portion of the pressurized boil-off gas forming the second reliquefied and pressurized gas portion;
expanding the first reliquefied and pressurized gas portion and the second reliquefied and pressurized gas portion separately; and
after being expanded to lower, common pressure, combining at least majority the first and the second reliquefied gas portions and leading the combined stream back to the gas storage.

19. A method according to claim 18, wherein increasing pressure of the boil-off gas comprises:
applying two compression stages, and cooling the partially pressurized boil-off gas between two compression stages in a liquid pool heat exchanger; and
cooling at least one of the first reliquefied and pressurized gas portion, and the second reliquefied and pressurized gas portion, in the liquid pool heat exchanger prior to expanding to lower pressure, wherein a pond of liquid gas is formed at a bottom part of the liquid pool heat exchanger which receives heat from the cooled reliquefied and pressurized gas portion.

20. A method according to claim 16, wherein the first reliquefied and pressurized gas portion include components of the boil-off gas capable, at the prevailing pressure, of reliquefication at a temperature of sea water, and the thermoelectric cooler reliquefies the remaining components of the boil-off gas.

21. Method according to claim 15, wherein electric power input to the thermoelectric cooler is controlled by:
measuring pressure of the gas upstream the thermoelectric cooler;
setting a target value to the pressure;
comparing the measured value to the target value; and
controlling electric power input to the thermoelectric cooler based on a signal obtained using the measured and target pressure value.

22. Method according to claim 23, wherein electric power input to the thermoelectric cooler is controlled by:
measuring pressure of the gas upstream to last compressor stage;
defining a pressure difference between the pressure of the gas upstream to last compressor stage and upstream the thermoelectric cooler;
setting a target value to the pressure difference;
comparing the measured value to the target value; and
controlling electric power input to the thermoelectric cooler based on a signal obtained using the measured and target pressure difference value.

23. An apparatus for reliquefying of boil-off gas stream obtained from liquefied gas in a gas storage of a floating storage unit, the apparatus comprising:
a gas compressor for increasing pressure of the boil-off gas providing pressurized boil-off gas;
a first condenser for reliquefying at least part of the pressurized boil-off gas;
a second condenser for reliquefying at least part of the remaining portion of the pressurized boil-off gas; and
at least one valve for expanding reliquefied and pressurized gas portions to lower pressure;
wherein the second condenser includes a thermoelectric cooler including a first heat exchanger in which the remaining portion of the pressurized boil-off gas stream is arranged to reliquefy, and a second heat exchanger in which a heat receiving transfer medium is arranged to flow, and a power management system for supplying electric power to the thermoelectric elements of the thermoelectric cooler in controllable manner.

24. An apparatus method according to claim 22, wherein the first condenser comprises:
a heat exchanger which is configured and arranged to extract heat from the pressurized boil-off gas, and to transfer heat to sea water directly or indirectly thus reliquefying at least part of the pressurized boil-off gas.

25. An apparatus according to claim 22, wherein the second heat exchanger of the thermoelectric cooler is configured and arranged to transfer heat to sea water directly or indirectly.

26. An apparatus according to claim 22, wherein the apparatus comprises:
a first gas-liquid separator after the first condenser arranged to separate the first reliquefied and pressurized gas portion from the remaining portion of the pressurized boil-off gas; and
a second gas-liquid separator after the second condenser.

27. An apparatus according to claim 22, wherein the gas compressor comprises:
two or more stages, and a gas cooler between two compression stages, and the gas cooler between two stages includes a liquid pool heat exchanger.

28. An apparatus according to claim 22, comprising:
a pressure probe arranged upstream the thermoelectric cooler in data transfer communication with the power management system.
